(19) United States
(12) Patent Application Publication
(10) Pub. No.: US 2026/0223221 A1
(43) Pub. Date: Jul. 30, 2026

(54) WIRELESS COMMUNICATION SYSTEM, WIRELESS COMMUNICATION DEVICE, WIRELESS COMMUNICATION METHOD AND WIRELESS COMMUNICATION PROGRAM

(71) Applicant: Nippon Telegraph and Telephone Corporation, Tokyo (JP)

(72) Inventors: Kotaro NAGANO, Musashino-shi, Tokyo (JP); Hirantha Abeysekera, Musashino-shi, Tokyo (JP); Yusuke Asai, Musashino-shi, Tokyo (JP); Yasushi TAKATORI, Musashino-shi, Tokyo (JP)

(21) Appl. No.: 19/143,284

(22) PCT Filed: Jan. 12, 2023
(86) PCT No.: PCT/JP2023/000663

§ 371 Date: Jun. 25, 2025

(51) Int. Cl. H04W 76/15; H04W 72/56; H04W 84/12

(52) U.S. Cl. CPC H04W 76/15; H04W 72/56; H04W 84/12

(57) ABSTRACT

The present disclosure relates to a wireless communication system, and an object of the present disclosure is to provide a wireless communication system that realizes high communication efficiency and a high reliability by dividing data according to an importance level of transmission data for scalable content data and assigning the divided data to a suitable link in multi-link wireless communication. A wireless communication system according to the present disclosure includes a transmitter and a receiver that allows a plurality of links to be connected between the transmitter and the receiver. The content data includes a plurality of pieces of data obtained by performing hierarchy classification based on an importance level. The transmitter is configured to execute processing of preferentially assigning a link having a good communication quality to data having a high importance level among the pieces of data, processing of bit-decomposing the content data according to the number of links to be assigned, and processing of transmitting the decomposed data to the receiver via each of the links to be assigned. The receiver is configured to execute processing of reconfiguring the content data from a plurality of pieces of the decomposed data.

### FIELD

The present invention relates to a wireless communication system, a wireless communication device, a wireless communication method, and a wireless communication program for multi-link transmission and reception of scalable content data.

### BACKGROUND

A technique for configuring a plurality of communication lines (multi-links) by a multi link device (MLD) provided with a plurality of wireless interfaces has been studied in accordance with a demand for increasing a transmission capacity and a transmission rate (refer to, for example, Patent Literature 1). In the multi-link, it is important to efficiently assign data to each line.

### CITATION LIST

### Non Patent Literature

Non Patent Literature 1: Wireless LAN “WIRELESS BEAM” Achieving Both Long Distance and Large Capacity, https://atmarkit.itmedia.co.jp/ad/harada/0602wbeam/wbeam.html

### SUMMARY

### Technical Problem

Since a wireless line has a higher error rate than a wired line and a quality of the line varies with time, an assignment amount of communication does not match an effective transmission rate of each line, and there is a line in which communication is not easily ended. As a result, there is a problem that the effective bandwidth use efficiency is lowered as a whole.

In order to solve the above-described problems, a first object of the present disclosure is to provide a wireless communication system that realizes high communication efficiency and a high reliability by dividing data according to an importance level of transmission data for scalable content data and assigning the divided data to a suitable link in multi-link wireless communication.

Further, a second object of the present disclosure is to provide a wireless communication device that realizes high communication efficiency and a high reliability by dividing data according to an importance level of transmission data for scalable content data and assigning the divided data to a suitable link in multi-link wireless communication.

Further, a third object of the present disclosure is to provide a wireless communication method that realizes high communication efficiency and a high reliability by dividing data according to an importance level of transmission data for scalable content data and assigning the divided data to a suitable link in multi-link wireless communication.

Further, a fourth object of the present disclosure is to provide a wireless communication program that realizes high communication efficiency and a high reliability by dividing data according to an importance level of transmission data for scalable content data and assigning the divided data to a suitable link in multi-link wireless communication.

### Solution to Problem

According to a first aspect of the present disclosure, there is provided a wireless communication system that transmits and receives scalable content data by multi-link wireless communication, the wireless communication system comprising: a transmitter; and a receiver that allows a plurality of links to be connected between the transmitter and the receiver, in which the content data includes a plurality of pieces of data obtained by performing hierarchy classification based on an importance level, preferably, the transmitter is configured to execute: first assignment processing of preferentially assigning a link having a good communication quality among the plurality of links to data having a high importance level among the pieces of data; second assignment processing of assigning a link that is not adopted in the first assignment processing among the plurality of links to the data excluding the data having a high importance level; bit decomposition processing of bit-decomposing the data having a high importance level and the data excluding the data having a high importance level by using a predetermined rule according to the number of links to be assigned based on results of the first assignment processing and the second assignment processing; processing of transmitting a plurality of pieces of decomposed data that are generated by the bit decomposition processing to the receiver via each of the links to be assigned; and processing of transmitting information for reconfiguring the plurality of pieces of decomposed data to the receiver via at least one of the plurality of links, and the receiver is configured to execute: processing of receiving each of the plurality of pieces of decomposed data via each of the links to be assigned; processing of receiving the information for reconfiguring the decomposed data; and reconfiguration processing of reconfiguring the content data from the plurality of pieces of decomposed data based on the information for reconfiguring the decomposed data.

Further, according to a second aspect of the present disclosure, there is provided a wireless communication device that allows a plurality of links to be connected between the wireless communication device and a receiver and transmits scalable content data by multi-link wireless communication, in which the content data includes a plurality of pieces of data obtained by performing hierarchy classification based on an importance level, and preferably, the wireless communication device is configured to execute: first assignment processing of preferentially assigning a link having a good communication quality among the plurality of links to data having a high importance level among the pieces of data; second assignment processing of assigning a link that is not adopted in the first assignment processing among the plurality of links to the data excluding the data having a high importance level; bit decomposition processing of bit-decomposing the data having a high importance level and the data excluding the data having a high importance level by using a predetermined rule according to the number of links to be assigned based on results of the first assignment processing and the second assignment processing; processing of transmitting a plurality of pieces of decomposed data that are generated by the bit decomposition processing to the receiver via each of the links to be assigned; and processing of transmitting information for reconfiguring the plurality of pieces of decomposed data to the receiver via at least one of the plurality of links.

Further, according to a third aspect of the present disclosure, there is provided a multi-link wireless communication method for transmitting and receiving scalable content data via a plurality of links which are connected between a transmitter and a receiver, the content data including a plurality of pieces of data obtained by performing hierarchy classification based on an importance level, preferably, the wireless communication method comprising: performing, via the transmitter, first assignment processing of preferentially assigning a link having a good communication quality among the plurality of links to data having a high importance level among the pieces of data; performing, via the transmitter, second assignment processing of assigning a link that is not adopted in the first assignment processing among the plurality of links to the data excluding the data having a high importance level; performing, via the transmitter, bit decomposition processing of bit-decomposing the data having a high importance level and the data excluding the data having a high importance level by using a predetermined rule according to the number of links to be assigned based on results of the first assignment processing and the second assignment processing; performing, via the transmitter, processing of transmitting a plurality of pieces of decomposed data that are generated by the bit decomposition processing to the receiver via each of the links to be assigned; performing, via the transmitter, processing of transmitting information for reconfiguring the plurality of pieces of decomposed data to the receiver via at least one of the plurality of links; performing, via the receiver, processing of receiving each of the plurality of pieces of decomposed data via each of the links to be assigned; performing, via the receiver, processing of receiving the information for reconfiguring the decomposed data; and performing, via the receiver, reconfiguration processing of reconfiguring the content data from the plurality of pieces of decomposed data based on the information for reconfiguring the decomposed data.

Further, according to a fourth aspect of the present disclosure, there is provided a wireless communication program which is executed by a wireless communication device that allows a plurality of links to be connected between the wireless communication device and a receiver and transmits scalable content data by multi-link wireless communication, the content data including a plurality of pieces of data obtained by performing hierarchy classification based on an importance level, preferably, the wireless communication program causing the wireless communication device to execute: first assignment processing of preferentially assigning a link having a good communication quality among the plurality of links to data having a high importance level among the pieces of data; second assignment processing of assigning a link that is not adopted in the first assignment processing among the plurality of links to the data excluding the data having a high importance level; bit decomposition processing of bit-decomposing the data having a high importance level and the data excluding the data having a high importance level by using a predetermined rule according to the number of links to be assigned based on results of the first assignment processing and the second assignment processing; processing of transmitting a plurality of pieces of decomposed data that are generated by the bit decomposition processing to the receiver via each of the links to be assigned; and processing of transmitting information for reconfiguring the plurality of pieces of decomposed data to the receiver via at least one of the plurality of links.

### Advantageous Effects of Invention

According to the aspects of the present disclosure, it is possible to provide a wireless communication system, a wireless communication device, a wireless communication method, and a wireless communication program that realize high communication efficiency and a high reliability by dividing data according to an importance level of transmission data for scalable content data and assigning the divided data to a suitable link in multi-link wireless communication.

### BRIEF DESCRIPTION OF DRAWINGS

FIG. 1 is a configuration example of a wireless communication system according to an embodiment 1 of the present disclosure.

FIG. 2 is a block diagram illustrating a configuration example of a transmitter and a receiver according to the embodiment 1 of the present disclosure.

FIG. 3 is a diagram illustrating inputs and outputs of an assignment unit of the transmitter according to the embodiment 1 of the present disclosure.

FIG. 4 is a diagram illustrating narrowing-down processing to be performed by the transmitter according to the embodiment 1 of the present disclosure.

FIG. 5 is a flowchart of processing performed by the transmitter according to the embodiment 1 of the present disclosure.

FIG. 6 is a flowchart of assignment processing and bit decomposition processing that are performed by the assignment unit of the transmitter according to the embodiment 1 of the present disclosure.

FIG. 7 is a flowchart of processing performed by the receiver according to the embodiment 1 of the present disclosure.

FIG. 8 is a modification example of FIG. 6 according to the embodiment 1 of the present disclosure.

FIG. 9 is a modification example of FIG. 6 according to the embodiment 1 of the present disclosure.

FIG. 10 is a modification example of FIG. 9 according to the embodiment 1 of the present disclosure.

FIG. 11 is a modification example of FIG. 9 according to the embodiment 1 of the present disclosure.

FIG. 12 is an application example of the wireless communication system according to the embodiment 1 of the present disclosure.

FIG. 13 is a configuration example of a wireless communication system according to an embodiment 2 of the present disclosure.

FIG. 14 is a modification example of FIG. 13 according to the embodiment 2 of the present disclosure.

FIG. 15 is a modification example of FIG. 13 according to the embodiment 2 of the present disclosure.

### Description of Embodiments

### Embodiment 1

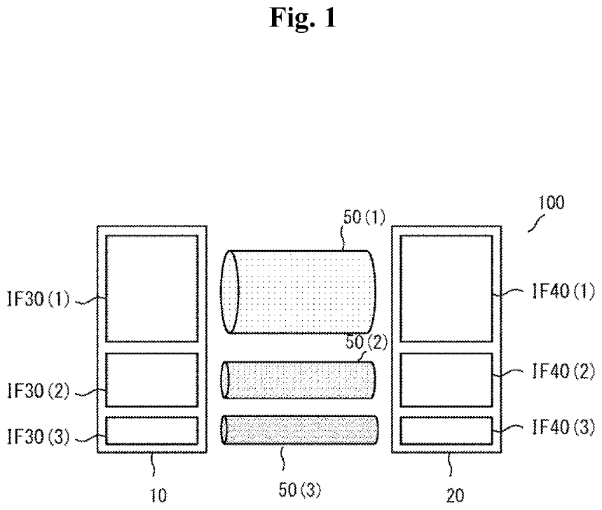

FIG. 1 is a configuration example of a wireless communication system 100 according to an embodiment 1 of the present disclosure. The wireless communication system 100 includes a transmitter 10 and a receiver 20.

Data that is to be transmitted from the transmitter 10 to the receiver 20 is scalable content data 13. For example, the data corresponds to a video or an image having scalability in a frame rate, a spatial resolution, an image quality, or the like. In addition, the data corresponds to a music or an audio having scalability in an audio quality or the like.

The transmitter 10 includes a plurality of wireless communication interfaces (hereinafter, referred to as IF) 30. The IF 30 of the transmitter 10 is, for example, a base station device. In addition, in a case where wireless communication to be applied is Wi-fi (registered trademark), the IF 30 is a wireless access point (AP).

A link 50(1) is connected between the IF 30(1) of the transmitter 10 and an IF 40(1) of the receiver 20. Similarly, a link 50(2) is connected between the IF 30(2) of the transmitter 10 and an IF 40(2) of the receiver 20, and a link 50(3) is connected between the IF 30(3) of the transmitter 10 and an IF 40(3) of the receiver 20.

A plurality of links 50 may have different communication capacities. In the example of FIG. 1, it is assumed that the link 50(1) has a largest communication capacity and the link 50(3) has a smallest communication capacity. Note that the communication capacity is, for example, an average value of effective throughput.

The transmitter 10 executes processing of dividing the scalable content data 13 into important data and additional data (hereinafter, referred to as data division processing). Note that the important data is data which guarantees a minimum quality of the scalable content data 13. For example, in a case of a video, the important data is data with which the video can be reconfigured by the data alone. Alternatively, the important data is high-priority data that is to be reliably transmitted from the transmitter 10 to the receiver 20, such as information related to control of the transmitter 10.

On the other hand, the additional data is data that can be used together with the important data to add value to the quality of the scalable content data 13. For example, in a case of a video, the additional data is data that can be used together with the important data to reconfigure a high-resolution video.

Further, the transmitter 10 executes processing (hereinafter, referred to as assignment processing.) of assigning the important data and the additional data to each of the plurality of links 50. Further, decomposed data which is assigned to each of the links 50 is transmitted from the IF 30 that is in charge of the link 50 to the receiver 20.

Similarly to the transmitter 10, the receiver 20 includes a plurality of IFs 40. The IF 40 of the receiver 20 is, for example, a wireless terminal device station (STA). The receiver 20 executes processing of reconfiguring the original content data 13 from the decomposed data that is received by each IF 40 (hereinafter, referred to as reconfiguration processing). As described above, it should be noted that the scalable data can be reconfigured by the receiver 20 even in a case where the scalable data is transmitted by being decomposed at different frame rates, different spatial resolutions, different image qualities, different audio qualities, or the like.

As described above, in the wireless communication system 100 according to the present disclosure, it is possible to divide the data according to an importance level of the content data 13 to be transmitted, and assign suitable links 50 according to the importance level of the divided data.

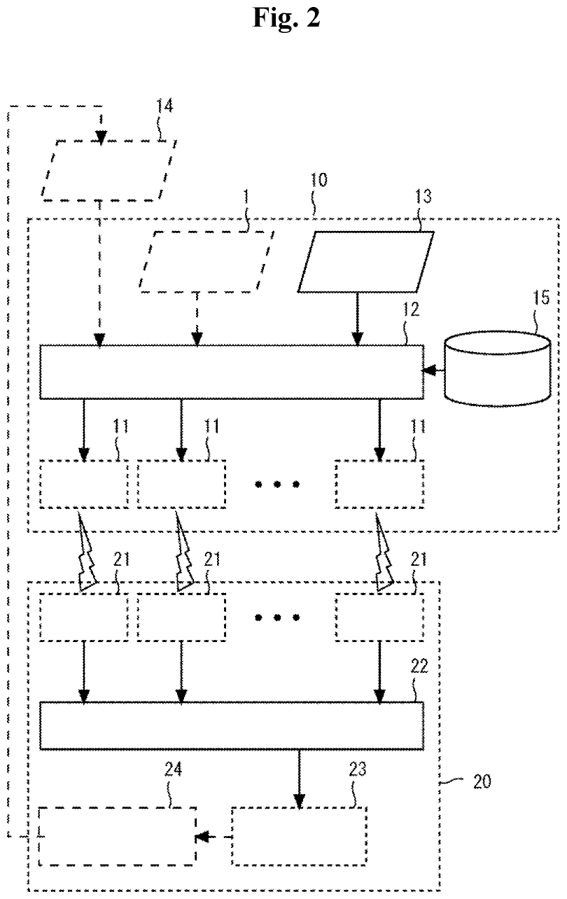

FIG. 2 is a block diagram illustrating a configuration example of the transmitter 10 and the receiver 20 according to the embodiment 1 of the present disclosure. The transmitter 10 includes an assignment unit 12. The assignment unit 12 executes processing of transmitting a measurement packet for measuring the communication quality of each of the plurality of links 50 to the receiver 20 (hereinafter, referred to as link quality measurement processing). Further, a result of the communication quality measurement is stored as link quality information 15. Note that the communication quality is a communication capacity, a bandwidth, a packet error rate (PER), an SN, a latency, and the like of the link 50.

Further, the assignment unit 12 executes the above-described data division processing on the content data 13 to be transmitted. Further, the above-described assignment processing is executed for each of the important data and the additional data that are generated by the data division processing. In the assignment processing, the link quality information 15 is considered.

Further, based on determination of the assignment processing, the assignment unit 12 further executes processing of bit-decomposing the important data and the additional data according to the number and the communication capacities of the links 50 to be assigned (hereinafter, referred to as bit decomposition processing).

Further, the assignment unit 12 executes processing of outputting data 16 which is bit-decomposed by the bit decomposition processing (hereinafter, referred to as decomposed data) to a transmission unit 11 that is in charge of the link 50 as an assignment destination (hereinafter, referred to as output processing).

Information for reconfiguring the decomposed data 16, such as a number and a bit width assigned to the decomposed data 16, is assigned to the same link 50 as the important data, and is transmitted to the receiver 20. With this information, in a case where the decomposed data 16 is received, the receiver 20 can reconfigure the original content data 13. Note that the information for reconfiguring the decomposed data 16 is not necessarily assigned to the same link 50 as the important data and may be assigned to the same link as the additional data.

Note that, in a case where user request information 14 is present, the assignment unit 12 executes the assignment processing after performing processing of narrowing down the links to be used for transmission of the content data 13 (hereinafter, referred to as narrowing-down processing) in consideration of the user request information 14. The user request information 14 includes a request related to a quality of the content data 13. In addition, the user request information 14 includes a request related to communication, such as a reliability and a latency. Note that the quality of the content data 13 corresponds to, for example, a peak signal-to-noise ratio (PSNR) in a case where the content data 13 is a video.

Note that, in a case where high-priority data 17 such as information related to a control of the transmitter 10 is present, the assignment unit 12 adds the high-priority data 17 to the important data and then executes the data division processing.

Note that, in a case where the content data 13 to be transmitted is a video, the assignment unit 12 may add frame reconfiguration information 18 to the important data.

Each of a plurality of transmission units 11 is the above-described IF 30 including one or more antennas capable of performing wireless communication. Each of the plurality of transmission units 11 transmits the decomposed data 16 that is received from the assignment unit 12 to a reception unit 21 of the receiver 20 to which the transmission unit 11 is connected via the link 50.

The receiver 20 includes a plurality of reception units 21. Each of the plurality of reception units 21 is the above-described IF 40 including one or more antennas capable of performing wireless communication. Each of the plurality of reception units 21 receives the decomposed data 16 from the transmission unit 11 of the transmitter 10 to which the reception unit 21 is connected via the link.

A reconfiguration unit 22 executes the above-described reconfiguration processing. A display/reproduction unit 23 is a display monitor or the like that displays the content data 13 which is reconfigured by the reconfiguration unit 22.

Further, in a case where the receiver 20 is notified of the user request information 14 from the user, a feedback unit 24 notifies the transmitter 10 of the user request information 14.

As described above, in the wireless communication system 100 according to the present disclosure, the transmitter 10 measures a communication quality of the link 50. Thereby, it is possible to perform control to preferentially assign the link 50 with good communication quality to the important data. Therefore, even in a case where the wireless propagation environment deteriorates, it is possible to transmit the important data to the receiver 20, and it is possible to improve the reliability of the wireless communication.

### <Modification Example>

In the above description, the example in which the receiver 20 is notified of the user request information 14 from the user has been described. On the other hand, the user request information 14 may be automatically generated by the receiver 20 based on a predetermined criterion. Further, the user request information 14 may not necessarily be generated by the receiver 20, and may be generated by another device and then transmitted to the transmitter 10.

The processing to be performed by the transmitter 10 and the receiver 20 may be executed by a program using a computer that includes a CPU and a memory and stores the program in the memory. Alternatively, the program may be executed using an integrated circuit such as a field programmable gate array (FPGA). Note that the program may be provided by being recorded in a storage medium, or may be provided through a network. This point is also common to the following embodiments.

Note that the communication quality measurement processing may be performed by the receiver 20 and the transmitter 10 may be notified of a result of the communication quality measurement processing.

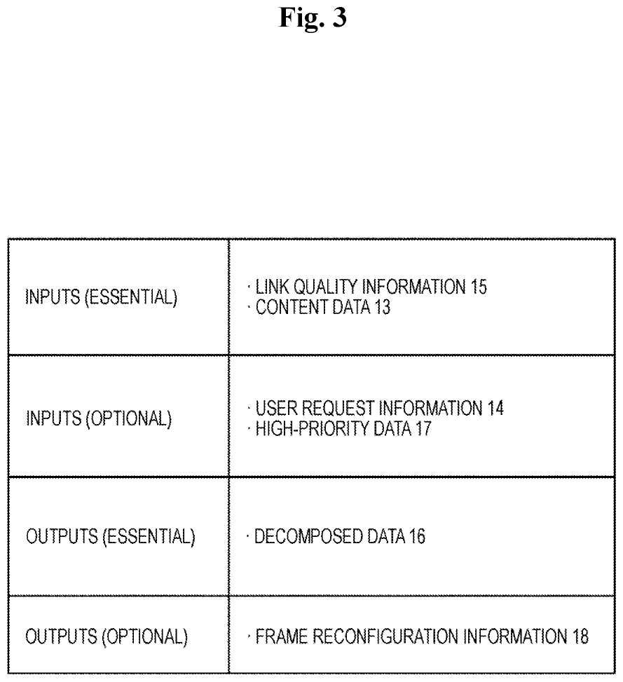

FIG. 3 is a diagram illustrating inputs and outputs of the assignment unit 12 of the transmitter 10 according to the embodiment 1 of the present disclosure. In the inputs of the assignment unit 12, the link quality information 15 and the content data 13 are essential. On the other hand, the user request information 14 and the high-priority data 17 may not be provided, and the same effect as described above can be obtained even in a case where the user request information and the high-priority data are not provided. In addition, in the outputs of the assignment unit 12, the decomposed data 16 is essential. On the other hand, the frame reconfiguration information 18 may not be provided, and the same effect as described above can be obtained even in a case where the frame reconfiguration information is not provided.

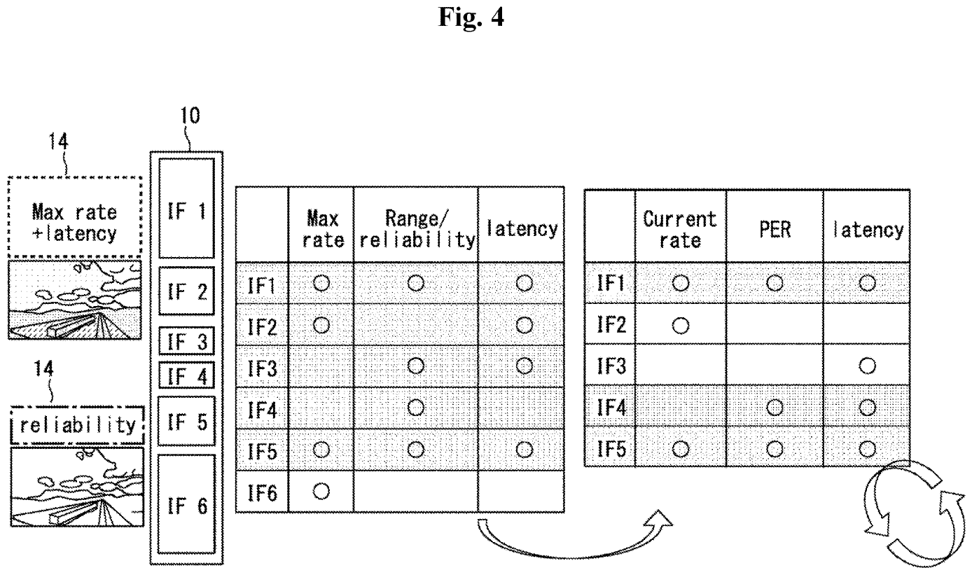

FIG. 4 is a diagram illustrating narrowing-down processing to be performed by the transmitter 10 according to the embodiment 1 of the present disclosure. Here, a case where the transmitter 10 includes six IFs 30 and six links 50 are connected between the transmitter 10 and the receiver 20 will be described. Further, as described above, the narrowing-down processing is executed in a case where the user request information 14 is present. Here, it is assumed that an improvement in communication rate, a low latency, and a reliability are requested in the user request information 14.

The transmitter 10 stores information of a type of a communication standard for each of the plurality of links 50 and basic information of each of the plurality of links 50. The type of the communication standard is, for example, IEEE802.11ah, ultra wide band (UWB), Wi-Fi of a normal standard using a 2.4 GHz band, a 5 GHz band, or a 6 GHz band, or the like. The basic information is information related to basic characteristics of the link 50, such as a maximum communication rate, a bandwidth, a communication capacity, a reliability, and a latency of the link 50. The transmitter 10 executes first narrowing-down processing of the links 50 to be used for transmission of the content data 13, among the plurality of links 50, based on the basic information.

A result of the first narrowing-down processing is shown in a left table of FIG. 4. From the viewpoint of the maximum communication rate (max rate), IF 1, IF 2, IF 5, and IF 6 are preferable. Similarly, IF 1, IF 3, IF 4, and IF 5 are preferable from the viewpoint of the bandwidth. reliability, and IF 1, IF 2, IF 3, and IF 5 are preferable from the viewpoint of the latency. Since an improvement in communication rate, a low latency, and a reliability are requested in the user request information 14, the transmitter 10 excludes the IF 6, which has a poor reliability and has poor latency characteristics, from candidates, and sets the remaining IF 1 to IF 5 as first candidates.

Next, the transmitter 10 executes communication quality measurement processing of the corresponding link 50 for each of the IF 1 to the IF 5 that are the first candidates. In the processing, actual values of items evaluated as the basic characteristics are evaluated. That is, for the maximum communication rate, the current communication rate (current rate) is evaluated, for the bandwidth. reliability, the PER is evaluated, and for the latency, the actual value is evaluated. It is assumed that a measurement result is as shown in a right table. The transmitter 10 executes second narrowing-down processing based on the result, and determines the link 50 to be used for transmission of the content data 13 from among the first candidates.

As described above, in the wireless communication system 100 according to the present disclosure, the transmitter 10 executes the first narrowing-down processing of the links 50 to be used for transmission of the content data 13 based on the basic information of each of the plurality of links 50. Further, the second narrowing-down processing is executed only for the links 50 that are candidates obtained by the first narrowing-down processing. Thereby, the accuracy of the narrowing-down processing of the links 50 can be improved, and the reliability can be improved. Furthermore, it is possible to reduce a cost required for the assignment of the links 50.

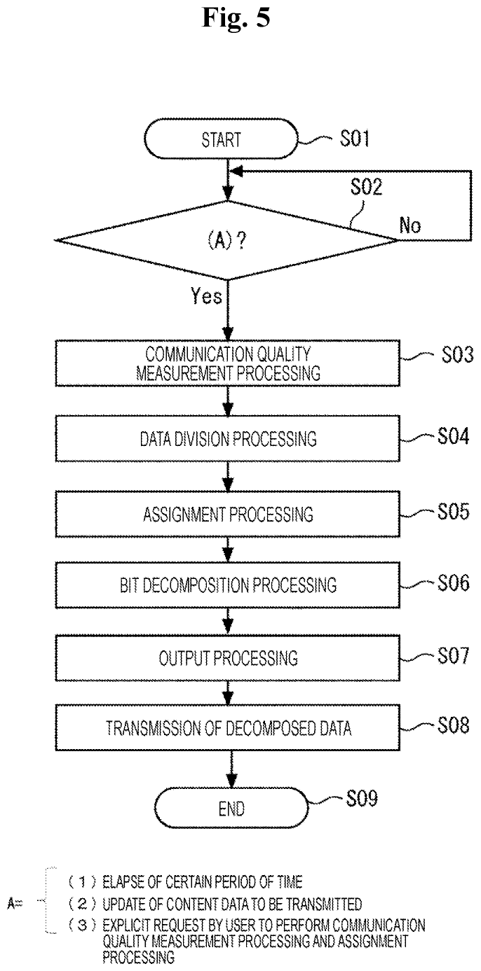

FIG. 5 is a flowchart of processing performed by the transmitter 10 according to the embodiment 1 of the present disclosure. First, processing is started (step S01).

Next, it is determined whether or not a trigger occurs (step S02). Note that the trigger is (1) elapse of a certain period of time, (2) update of the content data to be transmitted, (3) an explicit request by a user to perform communication quality measurement processing and assignment processing, or the like.

In a case where an occurrence of the trigger is recognized, the communication quality measurement processing is executed (step S03). Next, data division processing is executed (step S04). Further, assignment processing is executed on the important data and the additional data (step S05). Further, bit decomposition processing is executed (step S06). Further, output processing is executed (step S07). Next, each of the plurality of transmission units 11 transmits the decomposed data 16 to the reception unit 21 of the receiver 20 to which the transmission unit 11 is connected via the link 50 (step S08). Finally, the processing is ended (step S09).

As described above, in the wireless communication system 100 according to the present disclosure, the transmitter 10 performs the communication quality measurement processing and the assignment processing in response to the occurrence of the trigger. Thereby, the links 50 can be dynamically assigned according to the lapse of a certain period of time, the update of the content data to be transmitted, the temporal change in the communication quality of the link, and the like.

### <Modification Example>

Note that, in the lapse of a certain period of time that is a condition of the occurrence of the trigger, a length of time depends on a change rate of a channel.

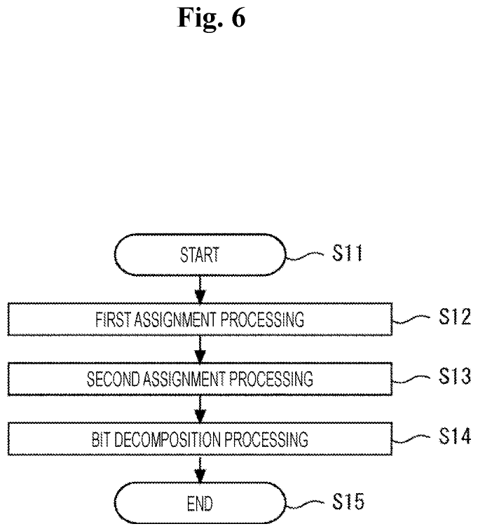

FIG. 6 is a flowchart of assignment processing and bit decomposition processing that are performed by the assignment unit 12 of the transmitter 10 according to the embodiment 1 of the present disclosure. Here, it is assumed that four links 50 are connected between the transmitter 10 and the receiver 20. In addition, it is assumed that a ratio of communication capacities of the link 50(1), the link 50(2), the link 50(3), and the link 50(4) is represented as A: B: C: D. In addition, it is assumed that the link 50(1) has a highest communication quality and the link 50(2) has a second highest communication quality.

First, processing is started (step S11). Further, processing (referred to as first assignment processing) of preferentially assigning a link 50 having a good communication quality to the important data based on the communication qualities measured in the communication quality measurement processing is executed (step S12).

Further, processing (referred to as a second assignment processing) of assigning a link 50, which has a relatively poor communication quality and is not adopted in the first assignment processing, to the additional data is executed (step S13). For example, it is assumed that the important data is assigned to the link 50(1) and the link 50(2) by the first assignment processing. In this case, the additional data is assigned to the link 50(3) and the link 50(4).

Further, the above-described bit decomposition processing is performed on the important data and the additional data (step S14). Here, bits of the original important data are decomposed into A: B. Further, bits of the original additional data are decomposed into C: D. Finally, the processing is ended (step S15).

As described above, in the assignment processing performed by the transmitter 10 according to the present disclosure, the link 50 having a good communication quality is preferentially assigned to the important data, and the link 50 that is not adopted for the assignment to the important data is assigned to the additional data. Thereby, the reliability of the wireless communication can be improved. In addition, in the bit decomposition processing performed by the transmitter 10, the important data and the additional data are bit-decomposed according to the number and the communication capacities of the links 50 to be assigned. Thereby, it is possible to assign the data according to the number and the communication capacities of the links, and efficient wireless communication can be realized.

### <Modification Example>

Note that, in a case where the important data is assigned, it is preferable to particularly consider the PER and the SN as the communication quality of the link 50. Therefore, in the first assignment processing, control may be performed such that a link 50 having a good PER characteristic and a good SN characteristic is extracted as a link having a high reliability from the plurality of links 50 and the important data is assigned to the link having a high reliability. Note that this point is also common to the following embodiments.

On the other hand, in a case where the additional data is assigned, it is preferable to particularly consider the bandwidth and the latency as the communication quality of the link 50. Therefore, in the second assignment processing, control may be performed such that a link 50 having a wide bandwidth and a low latency is assigned to the additional data from among the links 50 that are not adopted for the assignment to the important data. Note that this point is also common to the following embodiments.

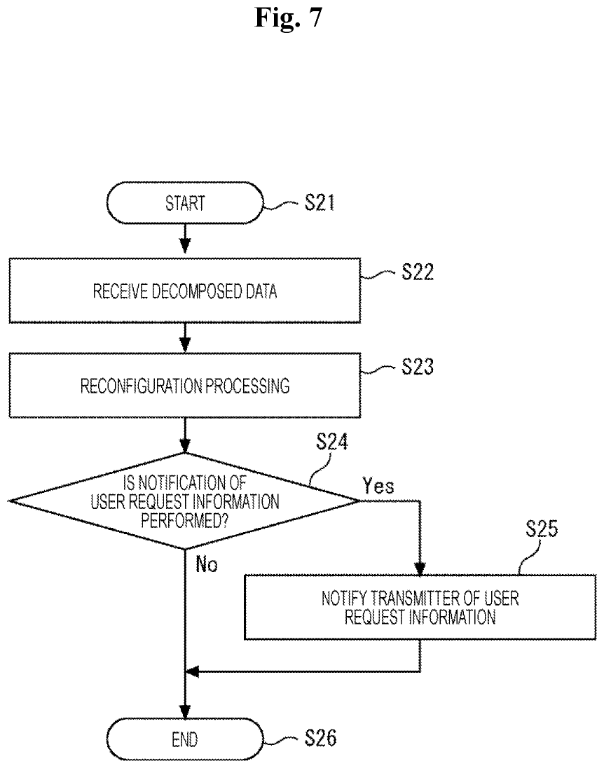

FIG. 7 is a flowchart of processing performed by the receiver 20 according to the embodiment 1 of the present disclosure. First, processing is started (step S21). Next, each of the reception units 21 receives the decomposed data 16 from the transmission unit 11 of the transmitter 10 to which the reception unit 21 is connected via the link (step S22). Further, the reconfiguration unit 22 executes reconfiguration processing (step S23). Further, it is determined whether or not notification of the user request information 14 from the user is performed (step S24). In a case where the notification is not acknowledged, the processing is ended (step S26). On the other hand, in a case where the notification is acknowledged, the feedback unit 24 notifies the transmitter 10 of the user request information 14 (step S25). Finally, the processing is ended (step S26).

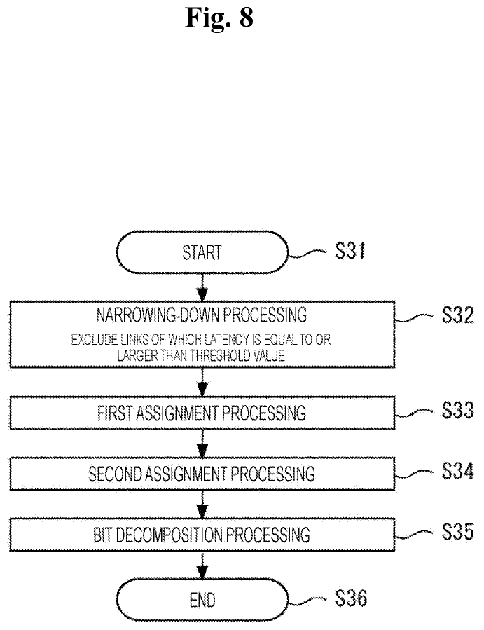

FIG. 8 is a modification example of FIG. 6 according to the embodiment 1 of the present disclosure. Here, it is assumed that a low latency is requested in the user request information 14.

First, processing is started (step S31). Further, narrowing-down processing is executed (step S32). In the narrowing-down processing, in consideration of the user request information 14, the links 50 of which the latency is equal to or larger than a threshold value are excluded, and the remaining links 50 are adopted as the links 50 for transmission of the content data 13. Further, first assignment processing is executed (step S33). In the first assignment processing, assignment is performed from among the links 50 that are adopted in the narrowing-down processing.

Further, second assignment processing is executed (step S34). In the second assignment processing, among the links 50 determined in the narrowing-down processing, the links 50 that are not adopted in the first assignment processing are used. Further, bit decomposition processing is executed (step S35). Finally, the processing is ended (step S36).

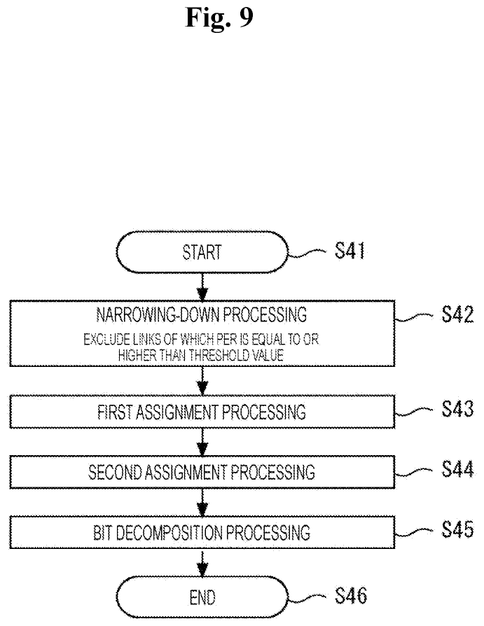

As described above, in a case where the user request information 14 is present, the transmitter 10 according to the present disclosure further executes the narrowing-down processing. In the first assignment processing, assignment is performed from among the links 50 that are adopted in the narrowing-down processing. In addition, in the second assignment processing, among the links 50 determined in the narrowing-down processing, the links 50 that are not adopted in the first assignment processing are used. Thereby, assignment of the links 50 can be suitably performed according to the user request information 14. Note that this point is also common to the following modification examples of FIG. 9 to FIG. 11.

FIG. 9 is a modification example of FIG. 6 according to the embodiment 1 of the present disclosure. Here, it is assumed that a reliability is requested in the user request information 14.

First, processing is started (step S41). Further, narrowing-down processing is executed (step S42). In the narrowing-down processing, in consideration of the user request information 14, the links 50 of which the PER is equal to or higher than a threshold value are excluded, and the remaining links 50 are adopted as the links 50 for transmission of the content data 13. Further, first assignment processing is executed (step S43).

Further, second assignment processing is executed (step S44). Further, bit decomposition processing is executed (step S45). Finally, the processing is ended (step S46).

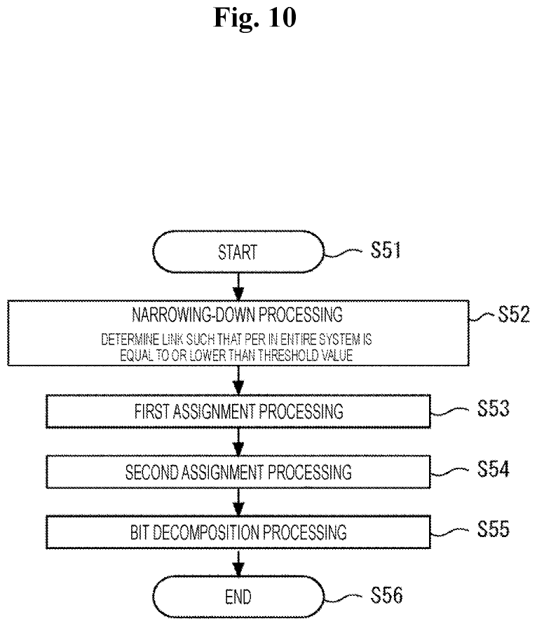

FIG. 10 is a modification example of FIG. 9 according to the embodiment 1 of the present disclosure. Here, it is assumed that a reliability is requested in the user request information 14.

First, processing is started (step S51). Further, narrowing-down processing is executed (step S52). Here, in the narrowing-down processing, unlike FIG. 9, a link to be used for transmission of the content data 13 is determined from among the plurality of links 50 such that the PER in the entire system is equal to or lower than a threshold value. As described above, by using the plurality of links 50 in a redundant manner, the communication efficiency can be further improved. Note that subsequent steps are the same as the steps in FIG. 9 and thus a description thereof is omitted.

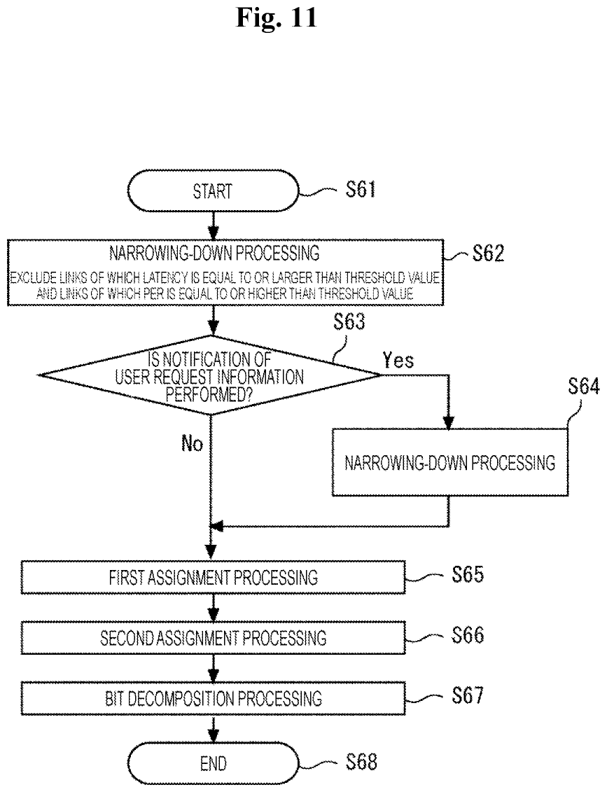

FIG. 11 is a modification example of FIG. 9 according to the embodiment 1 of the present disclosure. Here, it is assumed that the receiver 20 is notified of the user request information 14 during the processing and the quality of the content data 13 is requested.

First, processing is started (step S61). Further, narrowing-down processing is executed (step S62). In the narrowing-down processing, the links 50 of which the latency is equal to or larger than a threshold value and the links 50 of which the PER is equal to or higher than a threshold value are excluded, and the remaining links 50 are adopted as the links 50 for transmission of the content data 13.

Further, it is determined whether or not notification of the user request information 14 from the receiver 20 is performed (step S63). In a case where the notification is acknowledged, the links 50 excluded in step S62 are added to the candidates, and then the narrowing-down processing is executed again (step S64). Here, in the narrowing-down processing, the exclusion of the links 50 by using the threshold value for the latency is canceled in consideration of the user request information 14. Thereby, it is possible to adopt the links 50 having a good PER characteristic although the latency is larger than the threshold value. Thereby, it is possible to transmit the high-quality content data 13 to the receiver 20 although a latency occurs.

Further, first assignment processing is executed (step S65). Further, second assignment processing is executed (step S66). Further, bit decomposition processing is executed (step S67). Finally, the processing is ended (step S68). On the other hand, in a case where the notification is not acknowledged in step S63, the processing proceeds to step S65.

As described above, in a case where the transmitter 10 according to the present disclosure is notified of the user request information 14, the transmitter 10 executes the link narrowing-down processing and the assignment processing again. Thereby, it is possible to adopt suitable links 50 according to the user request information 14 and use the suitable links 50 for assignment.

As described above, according to the present embodiment, it is possible to provide the wireless communication system 100, the wireless communication method, the wireless communication device, and the wireless communication program that realize high communication efficiency and high reliability for communication of the scalable content data 13 in multi-link wireless communication.

### <Modification Example>

In the second assignment processing, the example in which the links 50 that are not adopted for assignment to the important data are assigned to the additional data has been described. On the other hand, the additional data may be multiplexed for the links 50 that are adopted for the assignment of the important data. For example, in a case where the quality of the content data 13 is requested in the user request information 14, the additional data is multiplexed for the links 50 that have a large communication capacity and are adopted for the assignment to the important data. Thereby, it is possible to efficiently transmit the additional data and improve the quality of the content data 13. Note that this point is also common to the following embodiments.

In the wireless communication system 100 according to the present disclosure, the above effect can be obtained as long as the number of the links 50 is two or more. Further, the link 50 may be a multi-hop link. Note that these points are also common to the following embodiments.

Note that, in the bit decomposition processing, the example in which the bit decomposition is performed on the important data and the additional data according to the ratio of the communication capacities of the plurality of links 50 has been described. On the other hand, bit decomposition may be performed according to a ratio of (throughput/latency) of each of the plurality of links 50. Thereby, it is possible to perform bit decomposition such that the latency is the same when viewed from a higher layer.

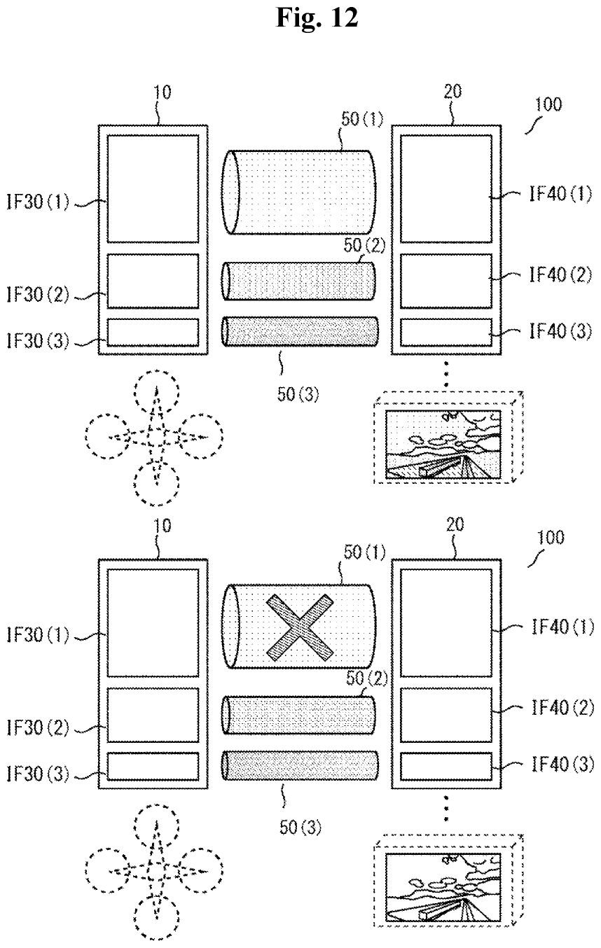

FIG. 12 is an application example of the wireless communication system 100 according to the embodiment 1 of the present disclosure. The wireless communication system 100 according to the present disclosure is particularly suitable in a case where the transmitter 10 is a drone and a video captured by the drone is transmitted to the receiver 20 as the content data 13. Here, it is assumed that low-resolution video data required at a minimum for controlling the drone is set as important data and video data required for obtaining a high-resolution video is set as additional data. As illustrated in an upper portion of FIG. 12, the drone normally assigns a link 50(1) having a large communication capacity to the additional data, and transmits the additional data to the receiver 20. On the other hand, as illustrated in a lower portion of FIG. 12, in a case where the wireless propagation environment deteriorates, the drone cuts out the additional data, and transmits only the important data to the receiver 20. Thereby, the reliability of the wireless communication can be improved.

### Embodiment 2

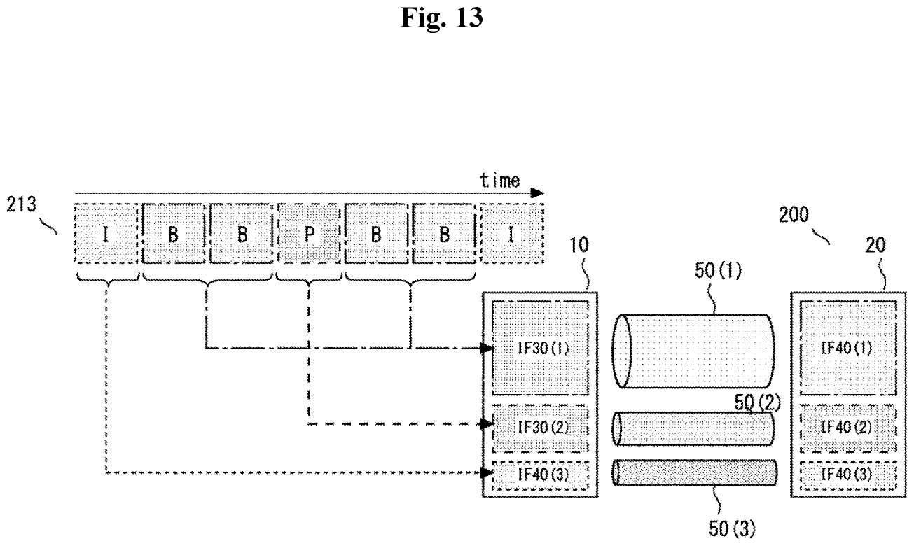

FIG. 13 is a configuration example of a wireless communication system 200 according to an embodiment 2 of the present disclosure. The wireless communication system 200 has the same configuration as the wireless communication system 100 according to the embodiment 1, but the content data 13 is video data 213 having temporal scalability. For example, the content data 13 corresponds to video data that is compressed according to an H.264/AVC format.

Three links 50 are connected between the transmitter 10 and the receiver 20. Here, the link 50(3) is a high-reliability link which has a smallest communication capacity and a slowest communication rate but has a best PER characteristic and a best SN characteristic among the three links 50. On the other hand, the link 50(1) is a high-rate link which has a worst PER characteristic and a worst SN characteristic but has a largest communication capacity and a fastest communication rate among the three links 50. On the other hand, it is assumed that the characteristic of the communication quality of the link 50(2) is intermediate between the characteristics of the link 50(1) and the link 50(3).

Hereinafter, the link 50(3) is referred to as a high-reliability link 50(3). Similarly, the link 50(1) is referred to as a high-rate link 50(1). For example, IEEE802.11ah, which uses a long range bandwidth of 920 MHz and adopts low communication rates, can be the high-reliability link 50(3). In addition, Wi-Fi5, Wi-Fi6, millimeter waves, or the like can be the high-rate link 50(1).

The video data 213 includes three frames of an I frame, a P frame, and a B frame. The I frame is a frame with which the video can be reconfigured by the frame alone. The P frame and the B frame are frames with which the video can be reconfigured by referring to information of the I frame. The I frame has a highest importance level. The P frame a second highest importance level, and the B frame has a third highest importance level. Further, in the example of FIG. 13, the number of the B frames is larger than the number of other frames.

As described above, in a case where the content data 13 includes a plurality of pieces of data obtained by performing hierarchy classification in advance based on the importance level, the transmitter 10 may not perform the data division processing. Further, in the assignment processing, assignment based on the importance level may be performed.

That is, in the assignment processing, the high-reliability link 50(3) is assigned to the data of the I frame having a highest importance level. Further, the link 50(2) that is intermediate in reliability characteristic is assigned to the P frame having a second highest importance level. Further, the high-rate link 50(1) is assigned to the B frame having a lowest importance level. By assigning the high-rate link 50(1) to the B frame having a lowest importance level and a large amount of data, it is possible to efficiently transmit the additional data.

As described above, in a case where the content data 13 includes a plurality of pieces of data obtained by performing hierarchy classification in advance based on the importance level, the transmitter 10 performs the assignment processing based on the importance level.

### <Modification Example>

In a case where a low latency is requested in the user request information 14, the B frame may be cut out, and the data of the I frame may be assigned to the high-rate link 50(1). Thereby, the content data 13 having a minimum quality can be transmitted to the receiver 20 without latency.

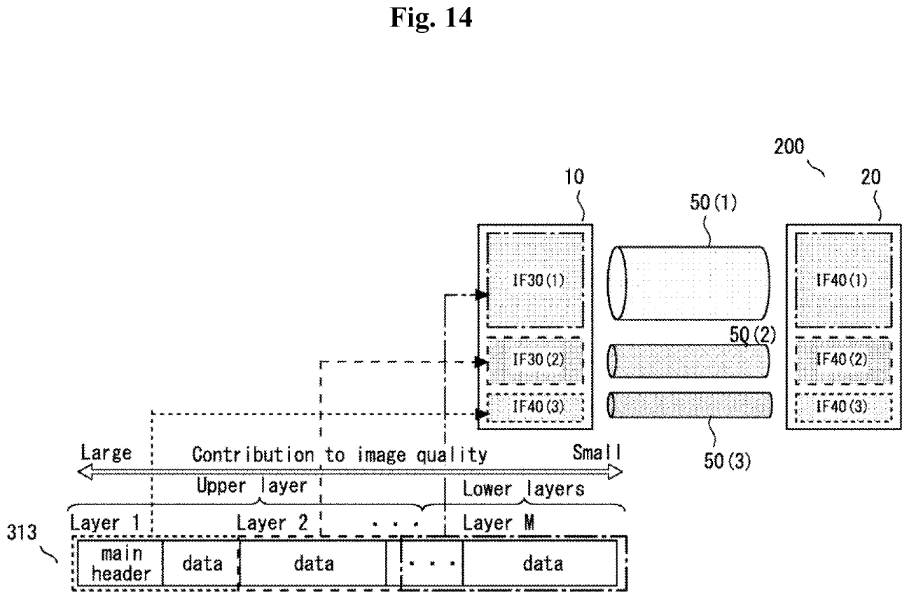

FIG. 14 is a modification example of FIG. 13 according to the embodiment 2 of the present disclosure. Here, the content data 13 is image data 313 having image quality scalability. For example, the content data 13 corresponds to image data that is compressed based on a JPEG 2000 format.

The image data 313 includes M layers including a layer 1, a layer 2, . . . , and a layer M. The layer 1 has a highest importance level. As the number assigned to the layer is larger, the importance level is lower.

Since the image data 313 is classified in advance according to the importance level, as in FIG. 13, the transmitter 10 executes assignment processing based on the importance level. That is, the layer 1 is assigned to the high-reliability link 50(3). In addition, the layer 2 and subsequent layers are divided into a group having a relatively high importance level and a group having a relatively low importance level. The transmitter 10 assigns the link 50(2) that is intermediate in reliability characteristic to the group that includes the layer 2 and has a relatively high importance level. In addition, the high-rate link 50(1) is assigned to the group having a relatively low importance level.

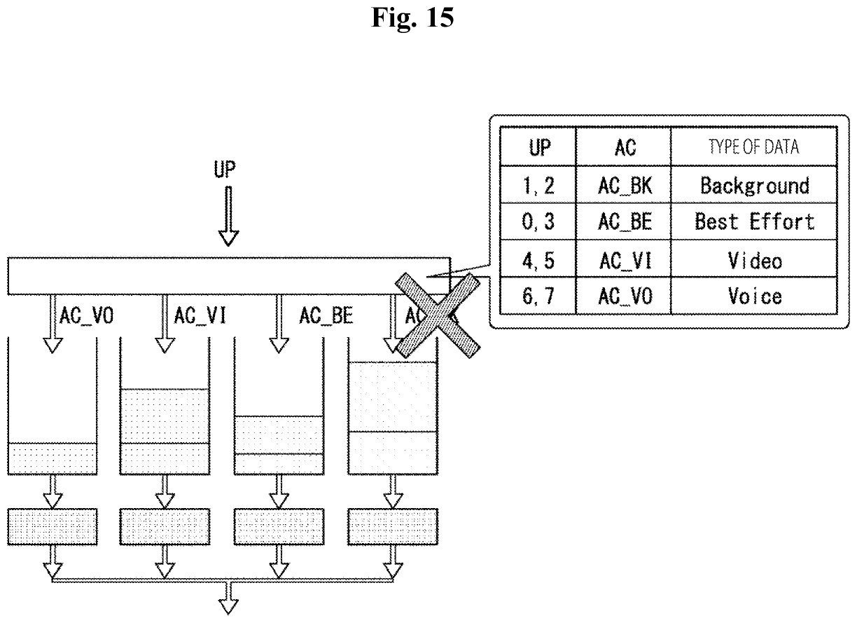

FIG. 15 is a modification example of FIG. 13 according to the embodiment 2 of the present disclosure. Here, priority control based on enhanced distributed channel access (EDCA) is applied to the wireless communication system 200. The content data 13 is classified into four access categories (AC) according to priority order information by a user priority (UP), and is stored in a transmission queue. AC_VO has a highest importance level, and AC_VI has a second highest importance level. AC_BE has a third highest importance level, and AC_BK has a fourth highest importance level.

As described above, in a case where the priority order information is received from the UP, the upper layer, or the like, as in FIG. 13, the transmitter 10 executes the assignment processing based on the priority order. For example, in a case where a low latency is requested in the user request information 14, the transmitter 10 cuts out the AC_BK having a lowest importance level and assigns only the remaining data to the link 50. Thereby, the content data 13 having a minimum quality can be transmitted to the receiver 20 without latency.

As described above, in the wireless communication system 200 according to the present embodiment, the transmitter 10 performs the assignment processing on the content data 13 based on the predetermined priority order.

### REFERENCE SIGNS LIST

10 Transmitter
11 Transmission unit
12 Assignment unit
13 Content data
14 User request information
15 Link quality information
16 Decomposed data
17 High-priority data
18 Frame reconfiguration information
20 Receiver
21 Reception unit
22 Reconfiguration unit
23 Display/reproduction unit
24 Feedback unit
30 IF
40 IF
50 Link
100 Wireless communication system
200 Wireless communication system
213 Video data
313 Image data

1. A wireless communication system that transmits and receives scalable content data by multi-link wireless communication, the wireless communication system comprising:
a transmitter; and
a receiver that allows a plurality of links to be connected between the transmitter and the receiver,
wherein the content data includes a plurality of pieces of data obtained by performing hierarchy classification based on an importance level,
the transmitter is configured to execute:
preferentially assigning a link having a good communication quality among the plurality of links to data having a high importance level among the pieces of data as first assignment;
assigning a link that is not adopted in the first assignment among the plurality of links to the data excluding the data having a high importance level as second assignment;
bit-decomposing the data having a high importance level and the data excluding the data having a high importance level by using a predetermined rule according to the number of links to be assigned based on results of the first assignment and the second assignment;
transmitting a plurality of pieces of decomposed data that are generated by the bit decomposition to the receiver via each of the links to be assigned; and
transmitting information for reconfiguring the plurality of pieces of decomposed data to the receiver via at least one of the plurality of links, and
the receiver is configured to execute:
receiving each of the plurality of pieces of decomposed data via each of the links to be assigned;
receiving the information for reconfiguring the decomposed data; and
reconfiguring the content data from the plurality of pieces of decomposed data based on the information for reconfiguring the decomposed data.

2. The wireless communication system according to claim 1,
wherein the hierarchy classification based on the importance level of the content data is executed by the transmitter.

3. The wireless communication system according to claim 1,
wherein the communication quality includes a packet error rate,
the transmitter or the receiver further executes measuring the communication quality of each of the plurality of links, and
the receiver further executes notifying the transmitter of a measurement result in a case where the receiver executes measurement of the communication quality.

4. The wireless communication system according to claim 1,
wherein the transmitter stores basic information of each of the plurality of links, and
in a case where the transmitter is notified of request information for a quality of the wireless communication or a quality of the content data,
the transmitter further executes:
extracting links suitable for the request information from the plurality of links based on the basic information and setting the links as first candidates;
measuring the communication quality for each of the links as the first candidates; and
further narrowing down links suitable for the request information from the first candidates based on a measurement result of the communication quality and determining links to be used for transmission of the content data.

5. The wireless communication system according to claim 1,
wherein the predetermined rule is a rule for bit-decomposing the data having a high importance level and the data excluding the data having a high importance level according to a ratio of communication capacities of the plurality of links or a ratio (throughput/latency) of each of the plurality of links.

6. A wireless communication device that allows a plurality of links to be connected between the wireless communication device and a receiver and transmits scalable content data by multi-link wireless communication,
wherein the content data includes a plurality of pieces of data obtained by performing hierarchy classification based on an importance level, and
the wireless communication device is configured to execute:
preferentially assigning a link having a good communication quality among the plurality of links to data having a high importance level among the pieces of data as first assignment;
assigning a link that is not adopted in the first assignment among the plurality of links to the data excluding the data having a high importance level as second assignment;
bit-decomposing the data having a high importance level and the data excluding the data having a high importance level by using a predetermined rule according to the number of links to be assigned based on results of the first assignment and the second assignment;
transmitting a plurality of pieces of decomposed data that are generated by the bit decomposition to the receiver via each of the links to be assigned; and
transmitting information for reconfiguring the plurality of pieces of decomposed data to the receiver via at least one of the plurality of links.

7. A multi-link wireless communication method for transmitting and receiving scalable content data via a plurality of links which are connected between a transmitter and a receiver, the content data including a plurality of pieces of data obtained by performing hierarchy classification based on an importance level, the wireless communication method comprising:
preferentially assigning, via the transmitter, a link having a good communication quality among the plurality of links to data having a high importance level among the pieces of data as first assignment;
assigning, via the transmitter, a link that is not adopted in the first assignment among the plurality of links to the data excluding the data having a high importance level as second assignment;
bit-decomposing, via the transmitter, the data having a high importance level and the data excluding the data having a high importance level by using a predetermined rule according to the number of links to be assigned based on results of the first assignment and the second assignment;
transmitting, via the transmitter, a plurality of pieces of decomposed data that are generated by the bit decomposition to the receiver via each of the links to be assigned;
transmitting, via the transmitter, information for reconfiguring the plurality of pieces of decomposed data to the receiver via at least one of the plurality of links;
receiving, via the receiver, each of the plurality of pieces of decomposed data via each of the links to be assigned;
receiving, via the receiver, the information for reconfiguring the decomposed data; and
reconfiguring, via the receiver, the content data from the plurality of pieces of decomposed data based on the information for reconfiguring the decomposed data.

8. A storage medium storing a computer readable wireless communication program which is executed by the wireless communication device according to claim 6, that allows a plurality of links to be connected between the wireless communication device and a receiver and transmits scalable content data by multi-link wireless communication, the content data including a plurality of pieces of data obtained by performing hierarchy classification based on an importance level, the wireless communication program including a program causing one or more processer included in the wireless communication device to execute:
preferentially assigning a link having a good communication quality among the plurality of links to data having a high importance level among the pieces of data as first assignment;
assigning a link that is not adopted in the first assignment among the plurality of links to the data excluding the data having a high importance level as second assignment;
bit-decomposing the data having a high importance level and the data excluding the data having a high importance level by using a predetermined rule according to the number of links to be assigned based on results of the first assignment and the second assignment;
transmitting a plurality of pieces of decomposed data that are generated by the bit decomposition to the receiver via each of the links to be assigned; and
transmitting information for reconfiguring the plurality of pieces of decomposed data to the receiver via at least one of the plurality of links.

9. The wireless communication system according to claim 2,
wherein the communication quality includes a packet error rate,
the transmitter or the receiver further executes measuring the communication quality of each of the plurality of links, and
the receiver further executes notifying the transmitter of a measurement result in a case where the receiver executes measurement of the communication quality.

10. The wireless communication system according to claim 2,
wherein the transmitter stores basic information of each of the plurality of links, and
in a case where the transmitter is notified of request information for a quality of the wireless communication or a quality of the content data,
the transmitter further executes:
extracting links suitable for the request information from the plurality of links based on the basic information and setting the links as first candidates;
measuring the communication quality for each of the links as the first candidates; and
further narrowing down links suitable for the request information from the first candidates based on a measurement result of the communication quality and determining links to be used for transmission of the content data.

11. The wireless communication system according to claim 2,
wherein the predetermined rule is a rule for bit-decomposing the data having a high importance level and the data excluding the data having a high importance level according to a ratio of communication capacities of the plurality of links or a ratio (throughput/latency) of each of the plurality of links.
